(19) United States
(12) Patent Application Publication
(10) Pub. No.: US 2008/0106061 A1
(43) Pub. Date: May 8, 2008

(54) Drive apparatus

(76) Inventor: Ohannes Meguerditchian, Glendale, CA (US)

Correspondence Address: ITALIA IP, 3500 WEST OLIVE AVE., SUITE 300, BURBANK, CA, 91505, US

(21) Appl. No.: 11/550,408

(22) Filed: Oct. 18, 2006

(51) Int. Cl. B62M 5/00

(52) U.S. Cl. 280/253

(57) ABSTRACT

A drive apparatus for the application of substantially linear drive force, wherein the substantially linear drive force is converted to a rotary propulsive force through the use of a substantially linear drive force accepting device, transferring the substantially linear drive force to rotary motion through a power transference device linked to the substantially linear drive force accepting device and transferring the rotary motion to a drive sprocket.

### BACKGROUND OF INVENTION

This application relates generally to a drive apparatus. More specifically, this application discloses a drive apparatus that converts a substantially linear driving force to a rotary propulsive force that may be used in a variety of applications such as to generate the propulsive force in a bicycle.

### SUMMARY

This application discloses a drive apparatus for converting a substantially linear driving force to a rotary propulsive force. The apparatus is of system of simple construction and can be used in a variety of applications including in standard bicycles, tricycles, reclining bicycles, personal watercraft such as paddle boats, scooters and any other similar transportation apparatus that uses a rotational force as a means to propel the transportation apparatus forward. The drive apparatus can also be uses in stationary exercise devises such at stationary bikes, stair climbers, and any devices that utilize a reciprocating substantially linear force as part of the exercise regimen.

In particular, this application discloses a drive apparatus for converting a substantially linear driving force to a rotary propulsive force, the drive apparatus comprising a frame; a pivot point located on said frame; a pedal assembly mechanically attached to said pivot point; wherein the pedal assembly includes a first and second pedal bracket wherein each bracket includes a pedal attachment region, a drive chain attachment region, and a pivot attachment region for attachment to said pivot point; a drive assembly located on said frame; wherein the drive assembly includes a drive axle positioned on said frame, a drive sprocket rotationally mounted on said axle, a first and second power sprocket rotationally mounted on said axle wherein said drive sprockets include internally mounted unidirectional clutch means; a power transference chain assembly mechanically connected to said pedal assembly and mechanically coupled to said drive assembly, and for mechanically connecting said pedal assembly to said drive assembly; wherein the power transference chain assembly includes a first and second power transference chain wherein each power transference chain has a pedal attachment end and a flexible cable attachment end and a power sprocket engagement region there between, a flexible cable fixedly attached between said power transference chains at said cable attachment ends, and a pulley fixedly attached to a pulley axle attached to said frame wherein said first power transference chain is fixedly attached to said first pedal bracket at said power transference chain attachment region and wherein said first power transference chain is mechanically coupled to said first power sprocket at said power sprocket engagement region and then fixedly attached to said flexible cable wherein said cable then engages said pulley and wherein said cable continues and is fixedly attached to said second power transference chain and wherein said second power transference chain is then mechanically coupled to said second power sprocket at said sprocket engagement region and then fixedly attached to said second pedal bracket at said power transference chain attachment region.

This application also discloses the above mentioned drive apparatus, but wherein the apparatus also comprises a reciprocating assembly; wherein the said reciprocating assembly includes a reciprocating cable with pedal a attachment means at each end, a first and second vertical pulley fixedly attached to a pulley axel attached to said frame, and a horizontal pulley fixedly attached to a pulley axle attached to said frame wherein said reciprocating cable is attached to said first pedal bracket at said cable attachment region and then engages said first vertical pulley and then engages said horizontal pulley and then said second vertical pulley and then attaches to said second pedal bracket at said cable attachment region.

This application also discloses a drive apparatus for converting a substantially linear driving force to a rotary propulsive force, the drive apparatus comprising substantially linear drive force accepting means; means for transferring said substantially linear drive force to rotary motion through a power transference means linked to said substantially linear drive force accepting means; and means for transferring said rotary motion to a drive sprocket.

Finally, this application discloses a an improved bicycle drive apparatus of the type wherein bicycle pedals are driven by the feet of a rider for rotating a drive sprocket which is coupled to a driven sprocket mounted on a wheel for the rotation thereof and the propulsion of the bicycle in a forward direction, the improvement comprising means for mounting said pedals for reciprocating substantially linear motion; means for transferring said reciprocating substantially linear motion to a unidirectional rotary motion through a power transference means linked to each of said pedals; means for transferring said unidirectional rotary motion to said drive sprocket; and means for coupling said unidirectional motion of said drive sprocket to said driven sprocket for propulsion of said bicycle.

### BRIEF DESCRIPTION OF THE DRAWINGS

The drawings, when considered in connection with the following description, are presented for the purpose of facilitating an understanding of the subject matter sought to be protected.

FIG. 1 is side plan view of a first embodiment of the drive apparatus disclosed herein incorporated on a bicycle;

FIG. 2 is an opposite side plan view of the bicycle and incorporated drive apparatus in FIG. 1;

FIG. 3 is side plan view of a first embodiment of the drive apparatus disclosed herein incorporated on a scooter;

FIG. 4 is an enlarged, fragmentary view of the drive apparatus in FIG. 3;

FIG. 5 is an enlarged, fragmentary, perspective view of the drive apparatus in FIG. 3;

FIG. 6 is an enlarged, fragmentary, perspective view of the reciprocating assembly of the drive apparatus in FIG. 3;

FIG. 7 is side plan view of a second embodiment of the drive apparatus disclosed herein incorporated on a reclining bicycle; and

FIG. 8 is an opposite side plan view of the bicycle and incorporated drive apparatus in FIG. 7;

### DETAILED DESCRIPTION

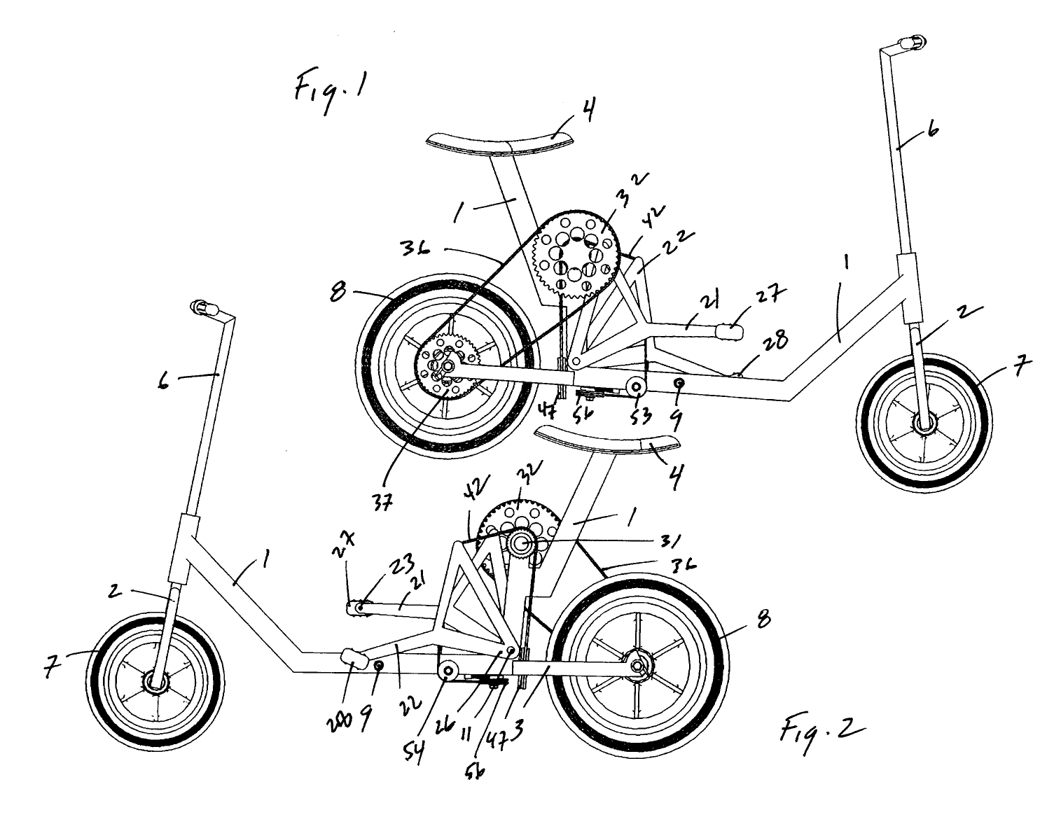

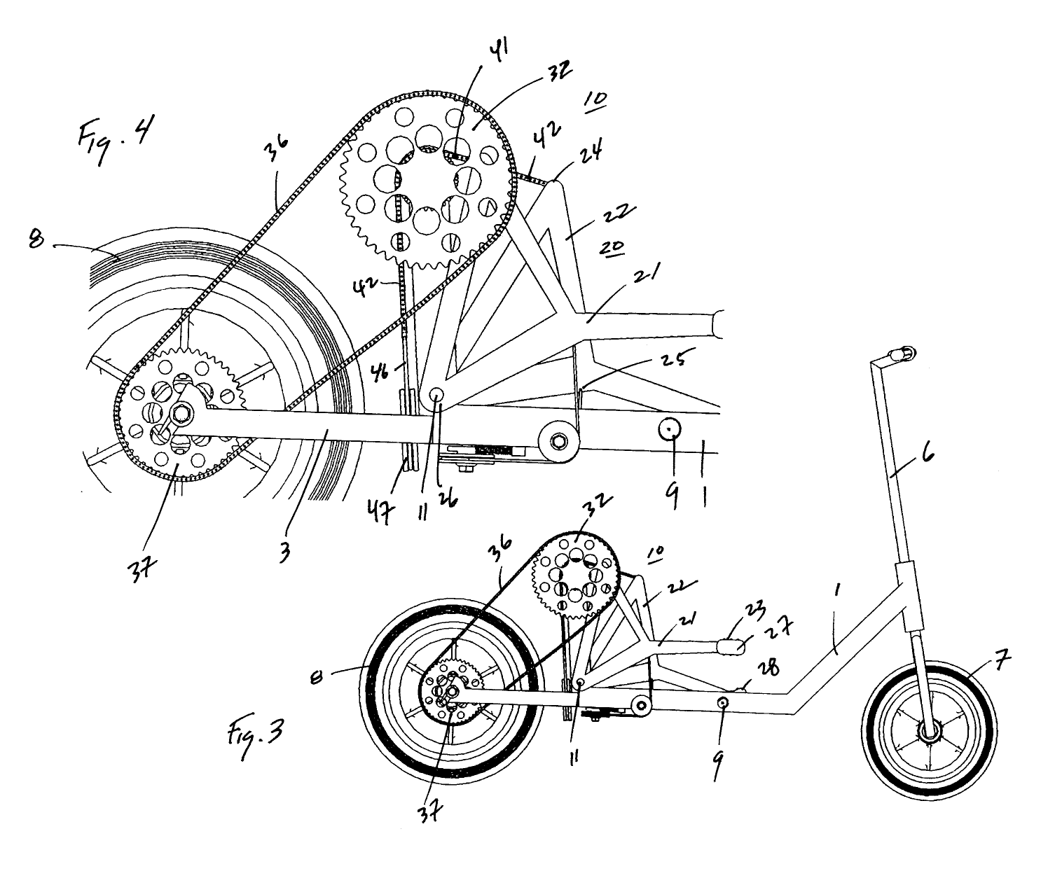

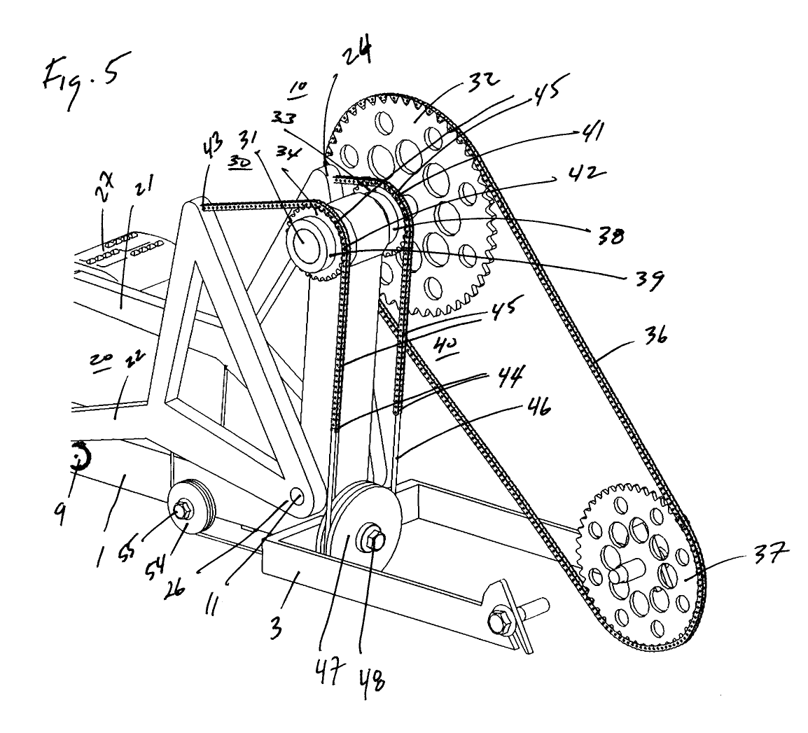

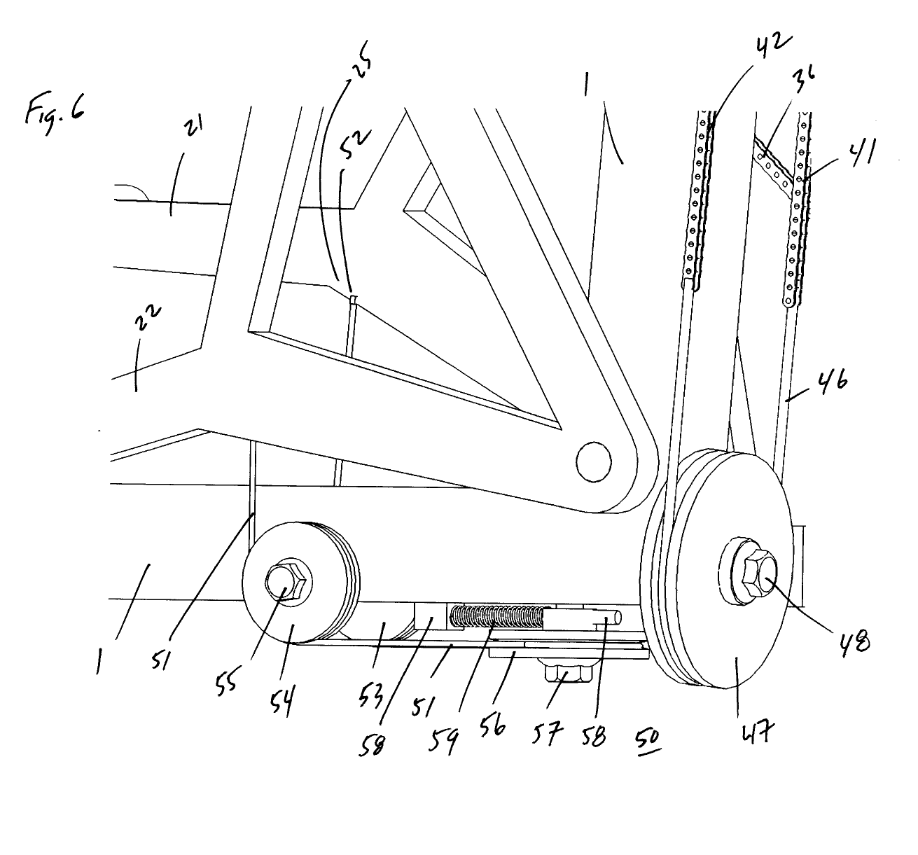

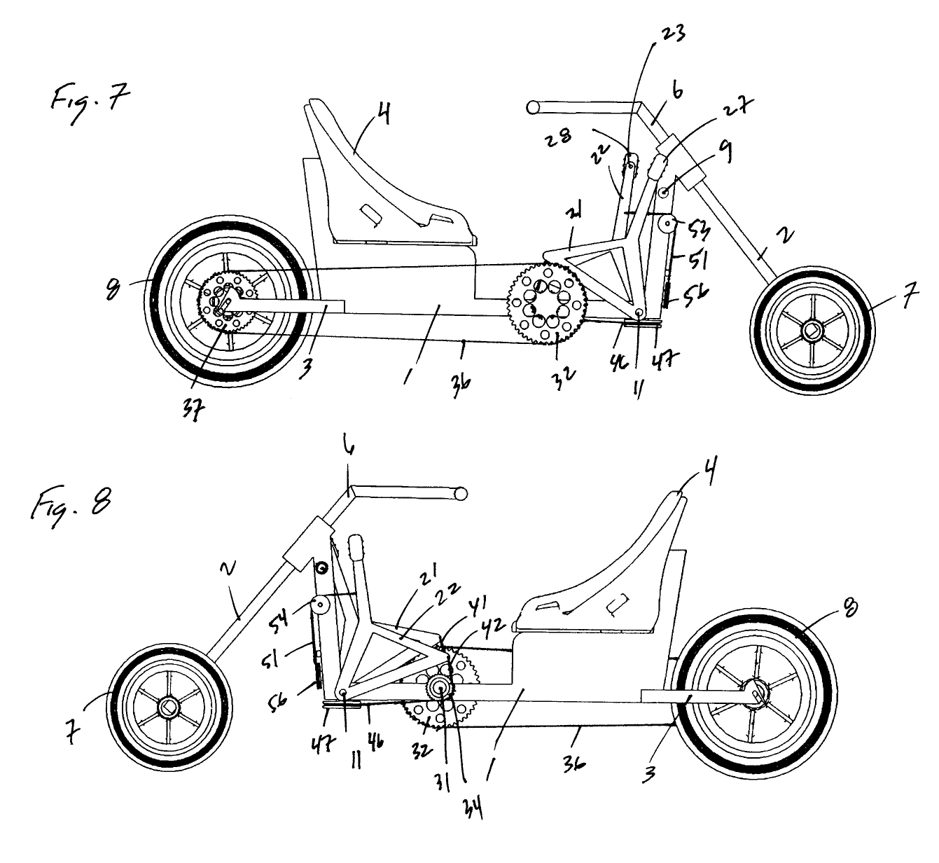

Referring to FIGS. 1-6, and specifically FIGS. 4 and 5, shown therein and generally designated by the reference character 10 is the drive apparatus 10 constructed in accordance with the following description. The first embodiment of the drive apparatus 10 is shown incorporated in a bicycle or a scooter in FIGS. 1-5. A second embodiment of the drive apparatus 10 is shown incorporated in a reclining bicycle in FIGS. 7 and 8. Regardless of the nature of the transportation device, which are well known in the art and shown for example purposes only, each is generally characterized by having a frame 1 that includes a front forks 2, rear forks 3, a seat 4, handle bars 6, and front 7 and rear 8 wheels.

The drive apparatus 10 includes a pivot point 11 located on said frame 1 that runs through the length of the frame for mechanical attachment of a the pedal assembly 20 such that the pedal assembly 20 can pivot about the pivot point 11. The attachment of the pedal assembly 20 may be mechanically attached to the pivot point 11 by means known in the art, such as a pivot axle. The pedal assembly 20 includes a first 21 and second pedal bracket 22 mechanically attached on opposite sides of the frame 1 and on opposite ends of said pivot axle. Not only can the pivot point for each pedal bracket 21 and 22 share the same pivot point 11 and pivot axle as described above, it is also contemplated that pivot point for each pedal bracket 21 and 22 could be independent of each other such that each pedal bracket 21 and 22 has its own pivot axle and whereby the pivot point 11 of each pedal bracket could be at the same or similar location on the frame 1. Each pedal bracket 21 and 22 includes a pedal attachment region 23 for attachment of pedals 27 and 28, a power transference chain attachment region 24, and a pivot attachment region 26 for attachment to said pivot point.

The drive apparatus 10 also includes a drive assembly 30 located on said frame 1. The drive assembly 30 includes a drive axle 31 positioned on the frame 1 that rotates within it. The drive assembly 30 also includes drive sprocket 32 rotationally mounted on the drive axle 31 such that when the drive axle 31 is rotated the drive sprocket 32 rotates. Also included in the drive assembly 30 is a first 33 and second 34 power sprocket rotationally mounted on the drive axle 31. The drive sprockets are mounted on internal unidirectional clutches 38 and 39 which are in turn mounted on the drive axle 31. The unidirectional clutches 38 and 39 enable the drive axle 31 to turn when the power sprockets 33 and 34 are rotated in the proper direction (clockwise). See FIG. 5. A detailed explanation of the operation of the drive apparatus 10 is presented below.

The drive apparatus 10 also includes a power transference chain assembly 40 mechanically connected to said pedal assembly 20 and mechanically coupled to said drive assembly 30, and for mechanically connecting said pedal assembly 20 to said drive assembly 30. The power transference chain assembly 40 including a first 41 and second 42 power transference chain wherein each power transference chain 41 and 42 has a pedal attachment end 43, a flexible cable attachment end 44, and a power sprocket engagement region 45 there between. The power transference chain assembly 40 includes a flexible cable 46 fixedly attached by a clasp or other similar means between said power transference chains 41 and 42 at cable attachment ends 44. The power transference chain assembly 40 further includes and pulley 47 fixedly attached to a pulley axle 48 attached to said frame 1.

The power transference chain assembly 40 is then assembled by fixedly attaching the first power transference chain 41 to the first pedal bracket 21 at the power transference chain attachment region 24. Then, the first power transference chain 41 is mechanically coupled to the first power sprocket 33 at the power sprocket engagement region 45 and then fixedly attached to the flexible cable 46. The flexible cable 46 then engages the pulley 47 and continues and is fixedly attached to the second power transference chain 42. The second power transference chain 42 is then mechanically coupled to the second power sprocket 34 at the sprocket engagement region 45 and then fixedly attached to the second pedal bracket 22 at the power transference chain attachment region 24. As just described, the drive apparatus 10 forms a first closed loop such that when pedal 27 is pushed downward by the rider, pedal 28 will automatically rise. See FIGS. 4 and 5.

During operation of the drive apparatus 10 the following events take place in converting a substantially linear driving force to a rotary propulsive force. Referring to FIGS. 4 and 5, a first embodiment of the drive apparatus 10 is shown incorporated in a bicycle or scooter where a rider places his or her feet on the pedals 27 and 28 attached respectively to the pedal brackets 21 and 22. The pedal brackets 21 and 22 act as a lever arms about pivot point 11 such that when the rider pushes down on the pedal 27, the foot travels downward in a substantially linear direction, in this example, a substantially vertical direction. As the pedals 27 and 28 reciprocate up and down attached to their respective pedal brackets 21 and 22, the power transference chains 41 and 42 are driven along their loop. The power transference chains 41 and 42 engage the teeth of the power sprockets 33 and 34. The power sprockets 33 and 34 are mounted on unidirectional clutches 38 and 39, which, in turn, are mounted upon the drive axle 31. The unidirectional clutches 38 and 39 enable the drive axle 31 to turn when the power sprockets 33 and 34 are rotated in the proper direction (clockwise) by the power transference chains 41 and 42. Thus, when the first power transference chain 41 is rotated clockwise, e.g., the first pedal bracket 21 and attached pedal 27 is pushed down, the unidirectional clutch 38 is not engaged and allows the first power sprocket 33 to turn the drive axle 31. At the same time, the second pedal bracket 22 and attached pedal 28 is pushed up, which causes the second power sprocket 34 to rotate counter-clockwise, thereby engaging the unidirectional clutch 39 which prevents the power sprocket 34 from attempting to rotate the drive axle 31. Consequently, there is always a rotational force being applied to the drive axle 31 by either one of the power sprockets 33 or 34. In this way the drive sprocket 34 is turned and causes drive chain 36 to rotate a driven sprocket 37. The range of upward and downward motion of each pedal bracket can be as much as 180°, however a range of approximately 40° to approximately 60° is preferred, and a range of approximately 45° to approximately 55° is particularly preferred. The downward movement of the pedal brackets 21 and 22 may be terminated by a pair of pedal bracket stops 9 which are mounted on the frame 1.

Referring to FIG. 6, the drive apparatus 10 may also include a reciprocating assembly 50. The reciprocating assembly 50 includes a reciprocating cable 51 with pedal attachment means 52 such as a screw at each end. The reciprocating assembly 50 also includes a first 53 and second 54 vertical pulley fixedly attached to a pulley axel 55 which is attached to the frame 1. The reciprocating assembly 50 also includes a horizontal pulley 56 fixedly attached to a pulley axle 57 attached to the frame 1. The reciprocating assembly 50 is assembled by attaching the reciprocating cable 51 to the first pedal bracket 21 at the cable attachment region 25. The flexible cable 51 then engages the first vertical pulley 53 and then continues on to engage the horizontal pulley 56, the second vertical pulley 54 before attaching to the second pedal bracket 22 at the cable attachment region 25. The reciprocating assembly 50 may also include a tensioning mechanism 58 mounted to the frame 1 and horizontal pulley 56, such as a high tension spring 59, so that the horizontal pulley 56 is forced in direction away from the vertical pulleys 53 and 54 thereby maintaining the desired tension in the reciprocating cable 51. As just described, the reciprocating assembly 50 forms a second closed loop such that when pedal 27 is pushed downward by the rider, pedal 28 will automatically rise. This second closed loop acts to maintain the tension not only on the reciprocating cable, but also on the on the power transference chains 41 and 42 and the flexible cable 46. This helps to prevent the power transference chains 41 and 42 from releasing from the power sprockets 33 and 34 and/or the flexible cable 46 from releasing from the pulley 47 when a rider quickly dismounts from the drive apparatus 10 thereby causing a sudden change in the tension applied to such devices which can potentially overcome the first closed loop as described above.

Referring to FIGS. 7 and 8, a second embodiment of the drive apparatus 10 is shown incorporated in a reclining bicycle where a rider places his or her feet on the pedals 27 and 28 attached respectively to the pedal brackets 21 and 22. The drive apparatus 10 acts substantially as described above, however, in this embodiment the pedal brackets 21 and 22 travel in a substantially horizontal direction.

While the present disclosure has been described in connection with what is considered the most practical and preferred embodiment, it is understood that this disclosure is not limited to the disclosed embodiments, but is intended to cover various arrangements included within the spirit and scope of the broadest interpretation so as to encompass all such modifications and equivalent arrangements. For example instead of the standard link chain common in the art for engaging the teeth of a sprocket as described above for both the power transference chains 41 and 42 and the drive chain 36, it should be understood that the disclosure includes the use of timing belts or other cables that would be able to similarly engage the teeth of a sprocket.

What is claimed is:

1. A drive apparatus for converting a substantially linear driving force to a rotary propulsive force, said apparatus comprising:
a frame;
a pivot point located on said frame;
a pedal assembly mechanically attached to said pivot point;
said pedal assembly including a first and second pedal bracket wherein each bracket includes a pedal attachment region, a power transference chain attachment region, and a pivot attachment region for attachment to said pivot point;
a drive assembly located on said frame;
said drive assembly including a drive axle positioned on said frame, a drive sprocket rotationally mounted on said axle, a first and second power sprocket rotationally mounted on said axle wherein said drive sprockets include internally mounted unidirectional clutch means;
a power transference chain assembly mechanically connected to said pedal assembly and mechanically coupled to said drive assembly, and for mechanically connecting said pedal assembly to said drive assembly; and
said power transference chain assembly including a first and second power transference chain wherein each power transference chain has a pedal attachment end and a flexible cable attachment end and a power sprocket engagement region there between, a flexible cable fixedly attached between said power transference chains at said cable attachment ends, and a pulley fixedly attached to a pulley axle attached to said frame wherein said first power transference chain is fixedly attached to said first pedal bracket at said power transference chain attachment region and wherein said first power transference chain is mechanically coupled to said first power sprocket at said power sprocket engagement region and then fixedly attached to said flexible cable wherein said cable then engages said pulley and wherein said cable continues and is fixedly attached to said second power transference chain and wherein said second power transference chain is then mechanically coupled to said second power sprocket at said sprocket engagement region and then fixedly attached to said second pedal bracket at said power transference chain attachment region.

2. The apparatus in claim 1 further comprising pedals attached to said first and second pedal brackets at said pedal attachment regions.

3. The apparatus in claim 2 wherein said power transference chain assembly causes said pedal brackets to reciprocate in opposite directions when a substantially linear driving force is applied to said pedals.

4. The apparatus in claim 3 wherein the reciprocation of said pedals causes the power transference chain assembly to rotate said power sprockets.

5. The apparatus in claim 1 wherein said power sprockets function unidirectionally such that a rotary propulsive force is generated in only one rotating direction, said unidirectional clutch means causing said power sprockets to actively engage said drive axle when rotating in such one rotating direction.

6. The apparatus in claim 1 wherein said rotary propulsive force of said drive axle is transferred to said drive sprocket.

7. The apparatus in claim 1 further comprising a drive chain linking said drive sprocket to a driven sprocket for the transfer of said rotary propulsive force to said driven sprocket.

8. The apparatus in claim 1 wherein the substantially linear driving force is in a substantially vertical direction.

9. The apparatus in claim 1 wherein the substantially linear driving force is in a substantially horizontal direction.

10. A drive apparatus for converting a substantially linear driving force to a rotary propulsive force, said apparatus comprising:
a frame;
a pivot point located on said frame;
a pedal assembly mechanically attached to said pivot point;
said pedal assembly including a first and second pedal bracket wherein each bracket includes a pedal attachment region, a drive chain attachment region, a cable attachment region, and a pivot attachment region for attachment to said pivot point;
a drive assembly located on said frame;
said drive assembly including a drive axle positioned on said frame, a drive sprocket rotationally mounted on said axle, a first and second power sprocket rotationally mounted on said axle wherein said drive sprockets include internally mounted unidirectional clutch means;
a power transference chain assembly mechanically connected to said pedal assembly and mechanically coupled to said drive assembly, and for mechanically connecting said pedal assembly to said drive assembly;
said power transference chain assembly including a first and second power transference chain wherein each power transference chain has a pedal attachment end and a flexible cable attachment end and a power sprocket engagement region there between, a flexible cable fixedly attached between said power transference chains at said cable attachment ends, and a pulley fixedly attached to a pulley axle attached to said frame wherein said first power transference chain is fixedly attached to said first pedal bracket at said power transference chain attachment region and wherein said first power transference chain is mechanically coupled to said first power sprocket at said power sprocket engagement region and then fixedly attached to said flexible cable wherein said cable then engages said pulley and wherein said cable continues and is fixedly attached to said second power transference chain and wherein said second power transference chain is then mechanically coupled to said second power sprocket at said sprocket engagement region and then fixedly attached to said second pedal bracket at said power transference chain attachment region;
a reciprocating assembly; and
said reciprocating assembly including a reciprocating cable with pedal a attachment means at each end, a first and second vertical pulley fixedly attached to a pulley axel attached to said frame, and a horizontal pulley fixedly attached to a pulley axle attached to said frame wherein said reciprocating cable is attached to said first pedal bracket at said cable attachment region and then engages said first vertical pulley and then engages said horizontal pulley and then said second vertical pulley and then attaches to said second pedal bracket at said cable attachment region.

11. The apparatus in claim 10 further comprising pedals attached to said first and second pedal brackets at said pedal attachment regions.

12. The apparatus in claim 11 wherein said power transference chain assembly and said reciprocating assembly maintain tension on said power transference chains, said flexible cable, and said reciprocating cable.

13. The apparatus in claim 12 wherein said power transference chain assembly and said reciprocating assembly causes said pedal brackets to reciprocate in opposite directions when a substantially linear driving force is applied to said pedals.

14. The apparatus in claim 13 wherein the reciprocation of said pedals causes the power transference chain assembly to rotate said power sprockets.

15. The apparatus in claim 10 wherein said power sprockets function unidirectionally such that a rotary propulsive force is generated in only one rotating direction, said unidirectional clutch means causing said power sprockets to actively engage said drive axle when rotating in such one rotating direction.

16. The apparatus in claim 10 wherein said rotary propulsive force of said drive axle is transferred to said drive sprocket.

17. The apparatus in claim 10 further comprising a drive chain linking said drive sprocket to a driven sprocket for the transfer of said rotary propulsive force to said driven sprocket.

18. The apparatus in claim 10 wherein the substantially linear driving force is in a substantially vertical direction.

19. The apparatus in claim 10 wherein the substantially linear driving force is in a substantially horizontal direction.

20. A drive apparatus for converting a substantially linear driving force to a rotary propulsive force, said apparatus comprising:
substantially linear drive force accepting means;
means for transferring said substantially linear drive force to rotary motion through a power transference means linked to said substantially linear drive force accepting means; and
means for transferring said rotary motion to a drive sprocket.

20. The apparatus of claim 20 further comprising means for coupling said rotary motion of said drive sprocket to a driven sprocket.

21. An improved bicycle drive apparatus of the type wherein bicycle pedals are driven by the feet of a rider for rotating a drive sprocket which is coupled to a driven sprocket mounted on a wheel for the rotation thereof and the propulsion of the bicycle in a forward direction, the improvement comprising:
means for mounting said pedals for reciprocating in a substantially linear motion;
means for transferring said reciprocating substantially linear motion to a unidirectional rotary motion through a power transference means linked to each of said pedals;
means for transferring said unidirectional rotary motion to said drive sprocket; and
means for coupling said unidirectional motion of said drive sprocket to said driven sprocket for propulsion of said bicycle.
